(19) United States
(12) Patent Application Publication
(10) Pub. No.: US 2012/0218629 A1
(43) Pub. Date: Aug. 30, 2012

(54) MICROSCOPE WITH MULTISPECTRAL ILLUMINATION OF AN OBJECT

(75) Inventors: Johannes WINTEROT, Jena (DE); Markus STICKER, Jena (DE)

(73) Assignee: CARL ZEISS MICROIMAGING GMBH, Jena (DE)

(21) Appl. No.: 13/404,990

(22) Filed: Feb. 24, 2012

(30) Foreign Application Priority Data
Feb. 28, 2011 (DE) 10 2011 004 819.7

(51) Int. Cl. G02B 21/36; G02B 21/06

(52) U.S. Cl. 359/363; 359/388; 359/390

(57) ABSTRACT

The disclosure provides a family of microscopes with components or discrete compact devices for illuminating an object with radiation of various spectral ranges suitable for multichannel fluorescence microscopy, so that an object is sequentially illuminated with different excitation spectra of particular fluorescent dyes. According to certain embodiments: several independent light-radiating surfaces are configured to radiate at different spectral ranges along an optical axis perpendicular to a plane defined by the surfaces and are spaced apart from each other, an optical illuminating system consisting of optical components, through which an illuminating ray path is directed at the object, wherein the surfaces are laterally offset from the optical axis of the optical illuminating system, and a deflecting mechanism configured for the sequential application of light coming from the light-radiating surfaces, so that as the direction changes, light enters the optical illuminating system and any lateral offset of the light-radiating surfaces is compensated.

### CROSS REFERENCE TO RELATED APPLICATION

This application claims priority to German National Patent Application No. DE10 2011 004 819.7, filed 28 Feb. 2011, the entire contents of which are hereby incorporated by reference herein.

### FIELD OF THE INVENTION

The invention relates to a microscope with components or a discrete compact device adapted for illuminating an object under examination with light of various spectral ranges, suitable especially for multichannel fluorescence microscopy, in which the object is illuminated with excitation spectra of particular fluorescent dyes in succession and the emission radiation thereby excited in the object is detected optically and analyzed. Varying with the embodiment of the device, the object can be imaged with reflected- or transmitted-light illumination.

### BACKGROUND OF THE INVENTION

Microscopes with object illuminating systems of this kind are known per se. For example, DE10 2005 054 184 A1 (and its U.S. equivalent —U.S. Pat. No. 8,097,865 issued 17 Jan. 2012) describes a multispectral illuminating device for microscopes which is provided with several semiconductor radiation sources, configured as laser, luminescent or light-emitting diodes (LEDs), high power LEDs and the like (described generically therein as semiconductor radiation sources), that deliver light of various wavelengths. Allocated to the semiconductor radiation sources are comparatively expensive color filters and optical components by means of which the light delivered at a time is coupled into a common illuminating ray path. As a disadvantage, this illuminating device occupies a relatively large amount of space. Moreover, combining the paths of the individual rays of light into the common illuminating ray path requires precise, technically complicated adjustment as well as careful matching of the color filter properties to avoid unwanted overlapping of wavelengths in object illumination.

Another multispectral illuminating device for microscopes is described in a published German patent application; namely, DE10 2008 015 720 A1 (and its corresponding U.S. equivalent application published 27 Jan. 2011 as U.S. publication no. 20110019272) in which several lighting units are arranged on a mechanically-articulated lamp changer by means of which the lighting units can be chosen and brought into the operating position. A filter changer (likewise mechanically-articulated) equipped with filter units is connected, via coupling elements, with the lamp changer in such a way that, with every change of the light unit, the light unit currently in the operating position is assigned, or coupled, to a single one of the filter units. A significant practical shortcoming relates to the great number of mechanically articulated components and, resulting therefrom, the relatively long time, or time lag, involved in switching between the desired spectral ranges.

### SUMMARY OF THE INVENTION

Departing from the prior art, the instant disclosure is based on solving the problem of developing a microscope that includes improved apparatus for illuminating an object to be imaged with light of various spectral ranges, in such a way that the changes of desired spectral ranges for illuminating the object can be achieved with shorter switching times. As a further solution to the problem(s) of the prior designs, the illuminating device is compact and thus occupies substantially less space.

According to the certain embodiments of the disclosure herein described, depicted and claimed, a family of microscopes with components or a discrete compact device for illuminating an object to be imaged with light of various spectral ranges include:

several light-radiating surfaces spaced apart or detached from each other,

an optical illuminating system consisting of optical components, through which an illuminating ray path is directed at the object, in which the light-radiating surfaces radiate from a single light-radiating surface or discrete member at a desired spectral range for each desired range, are arranged in a plane normal to the optical axis of the optical illuminating system (if disposed in a common plane), and are, in this plane, laterally offset from the optical axis, and

a deflecting means, configured for the sequential deflection of the light coming from the light-radiating surfaces, so that, as the direction changes, the light is deflected into the optical illuminating system and the lateral offset of the light-radiating surfaces is compensated.

In another embodiment optical fibers couple the spaced apart sources of radiant energy.

Thus, sequentially the light from a given light-radiating surface having a desired spectral range is directed at the object at a preselected time and other desired spectral range(s) are likewise directed at the object at a different time than the preselected time. This can be accomplished with suitable activation (e.g., via temporally controlled switches) or selective blocking of the radiant energy synchronized with desired spectral illumination of the object to be imaged.

In an embodiment of the invention, four light-radiating surfaces are provided, which concentrically surround the optical axis, with each light-radiating surface being, on principle, assigned to one quadrant of the overall light-radiating surface formed by the four separate light- radiating surfaces, and with each separate light-radiating surface (or discrete member or unit) being optically coupled with at least one light source, preferably a high-power LED. With particular preference, the light-radiating surfaces are provided directly on a quadruple LED arrangement, known in the field as a 2×2 LED chip, or a multi-colored four-chip LED, e.g., as those made or distributed by Perkin Elmer, Inc. of Waltham, Mass., U.S.A. By means of the different positions of the deflecting means, it is achieved that the object is illuminated by the light of a light exit surface that corresponds to a 1×1 partial area of such a 2×2 LED chip.

The invention may provide for all light sources being turned on permanently, with optical means being provided for excluding the spectral ranges currently not intended for illumination from coupling into the optical illuminating system, so that the object is illuminated only with light of a specified spectral range at a time. More advantageously, however, the light sources are turned on and off separately, with each light source being activated only for the time in which the object is intended to be illuminated with the spectral range generated by the respective light source.

This has the advantage that undesirable illumination of the object with so-called faulty light, or mixed-spectrum radiant energy, impinges upon the object that can be caused by the influence of the other spectral ranges is avoided during imaging of an object of interest.

The invented family of microscopes can thus be used for transmitted-light illumination. It is an essential idea of the invention to direct, with the aid of the deflecting means, the light coming from the offset light-radiating surfaces sequentially reaching a point relative to a collector at which—in a classical light microscope of the prior art—the source of the illuminating light is located, so that instead of this light source, so-called virtual light sources (which correspond to the separate light-radiating surfaces) are formed alternatingly in succession and correspondingly impinge upon the object of interest independently of other spectrum light energy.

In that respect, the deflecting means may be configured as a transparent glass plate that is arranged in the illuminating ray path between the light-radiating surfaces and the collector, tilted relative to the optical axis of the collector, and supported so as to be rotatable about the optical axis. Because of the specified tilt of the glass plate relative to the optical axis, the lateral offset between one of the light-radiating surfaces and the optical axis of the collector is compensated, and because of the rotation of the glass plate about the optical axis, the light of one of the light-radiating surfaces—depending on the current angle of rotation—is coupled into the illuminating ray path.

The glass plate can be made, e.g., from N-BK7 glass or other suitable optical material, having a thickness of three (3) mm and be arranged at a tilt angle of 45 degrees (45°) relative to the optical axis. Smaller tilt angles can be achieved with glass of greater thickness or a higher refractive index.

In an alternative version of transmitted-light illumination, the deflecting means is configured in the form of a rotatable supported mirror positioned at or at least near the collector's focal point facing away from the light-radiating surfaces. In the position of the mirror, the illuminating ray path is deflected. The rotation axis of the mirror coincides with the bisector of the angle a about which the optical axis of the optical illuminating system is deflected. The normal to the mirror surface is inclined by a specified angle β relative to the rotation axis, so that, due to the tilt of the mirror surface, the lateral offset between the light-radiating surfaces and the optical axis is compensated during the rotation. Because of the rotation of the mirror, the light of the active light-radiating surfaces—depending on the current angle of rotation—reaches the object.

The principle is applicable to both Koehler illumination and what is known as critical illumination. With Koehler illumination in a reflected-light microscope, the deflection is brought about in such a way that the image of the light-radiating surface is centered with the exit pupil of the microscope's objective. With critical illumination by reflected light, the deflection is effected in such a way that the image of the light-radiating surface is near, and centered with, the field diaphragm. In case of transmitted light, the objective is replaced by the condenser.

In case of the rotatable mirror, as also in case of the rotatable glass plate, both continuous and incremental rotation may be provided. Incremental rotation, e.g., about an angle of rotation of 90° between each of the four light-radiating surfaces arranged concentrically about the optical axis, is of advantage especially if visual observation of the object or recording an image of the object requires longer exposure times per spectral range than in the case of continuously changing illumination, as for example in fluorescence microscopy.

From that point of view, an exemplary embodiment of the invented microscope is configured for four-channel fluorescence microscopy, with the spectra of the separate light sources covering varied excitation spectra of certain fluorescent dyes contained in the object examined. The excitation spectra are radiated via the light-radiating surfaces. Preferably, the microscope is provided with control circuitry designed: to set a rotary speed for the glass plate or the mirror during continuous rotation, or to set dwell times for incremental rotation, to switch the light sources in synchronism with the angle of rotation of the glass plate or of the mirror, and to control a camera in synchronism with the rotary speed and the current angle of rotation, so that the control circuitry can be used for the sequential switching on and off of the various light sources, for illuminating, in synchronism therewith, the object with the light of one of the spectral ranges at a time, and in synchronism therewith allowing visual examination of the object or via its recording by the camera.

For the modes of operation described above, the offset may alternatively be provided in planes optically conjugated with the light-radiating surfaces, such as, e.g., the plane of the aperture diaphragm, in which case the imaging scale ratio between the respective light-radiating surface and the conjugated plane must be considered.

Instead of the 2×2 LED chips mentioned above, in which the light source and the light-radiating surface form a common unit and are directly coupled optically, it is also within the scope of the invention to spatially separate LEDs and light-radiating surfaces, in which case the light of separately arranged LEDs is guided to the light-radiating surfaces, e.g., by means of optical fibers, with the light-radiating surfaces forming a concentric ring arrangement around the optical axis and selecting the desired spectra light and sequentially making it available for object illumination as described above.

It is to be understood that the characteristics mentioned before as well as those explained below are applicable not only in the combinations stated but also in other combinations or singly without exceeding or departing from the gist of the invention.

### BRIEF DESCRIPTION OF THE DRAWINGS

Below, the invention will be explained in greater detail with reference to exemplary embodiments as depicted in the accompanying drawings.

FIGS. 1a and 1b depict schematically an example of an embodiment of one member of the family of the inventive microscopes including an arrangement for imaging the object with transmitted-light illumination, with a deflecting means being provided in the form of a transparent rotatable glass disk.

FIG. 2a shows an example of a collector in relation to a light source positioned centrically with the condenser's optical axis, as known in prior art, and in FIG. 2b relation to the light-radiating surfaces arranged according to an embodiment of the invention, with interposed deflecting means.

FIGS. 3a and 3b show an example of an embodiment of the invented microscope arrangement for imaging the object with reflected-light illumination.

FIGS. 4a and 4b show an example of an embodiment of the invented microscope arrangement for imaging the object with transmitted-light illumination, with a deflecting means being provided in the form of a rotatable mirror.

### DETAILED DESCRIPTION OF THE DRAWINGS

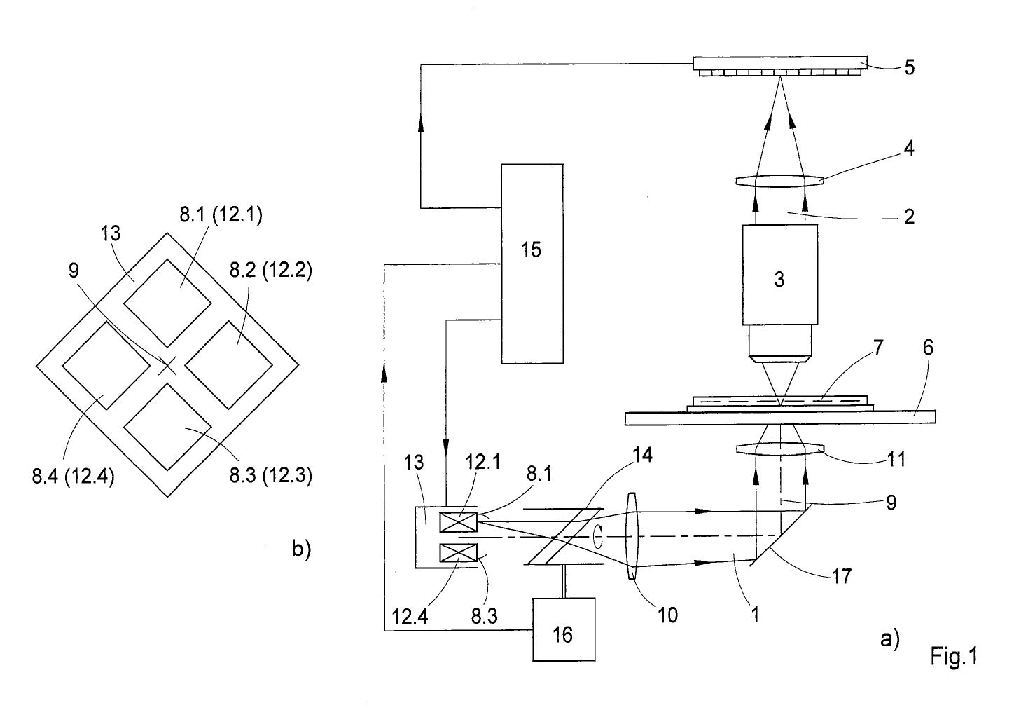

FIG. 1a illustrates the principle of the illuminating ray path 1 and the imaging ray path 2 of a microscope. Aligned in the imaging ray path 2 is an objective 3, a tube lens 4 and a camera 5 (suitably equipped with a digital image sensor, although not individually depicted in FIG. 1a). An object 7 to be imaged is placed on a specimen stage 6 so that the object 7 can be observed by transmitted light, sequentially using the light of, e.g., four separate spectral ranges, and to obtain one or several digital images of the object or of object details with each selected or all of the spectral ranges, if desired.

Accordingly, in one embodiment four detached light-radiating surfaces 8.1, 8.2, 8.3, 8.4 are provided (see FIG. 1b), which are arranged at an offset from the optical axis 9 of an optical illuminating system. The optical illuminating system comprises a collector 10 and a condenser 11. A fixed deflecting element 17 arranged between collector 10 and condenser 11 merely serves to change the direction of the illuminating ray path 1.

The light-radiating surfaces 8.1, 8.2, 8.3, 8.4 are arranged in such a way that they concentrically surround the optical axis 9 (denoted by a dashed line in FIG. 1a). FIG. 1b is a plan view of the light-radiating surfaces 8.1, 8.2, 8.3, 8.4 as seen against the radiating direction (i.e., orthogonal to the plane defined by the surface of the drawing page). Each of the light-radiating surfaces 8.1, 8.2, 8.3, 8.4 is optically coupled with a high-power LED 12.1, 12.2, 12.3, 12.4 as a light source that generates light of a certain specified spectral range and, due to the optical coupling, transmits it to the assigned light-radiating surface 8.1, 8.2, 8.3, 8.4, respectively.

The high-power LEDs 12.1, 12.2, 12.3, 12.4 and the light-radiating surfaces 8.1, 8.2, 8.3, 8.4 are compactly combined in a light source unit 13. Between the light source unit 13 and the collector 10 there is a deflecting means in the form of a transparent glass plate 14, which is tilted relative to the optical axis 9 by 45 degrees and supported so as to be rotatable about the optical axis 9, and which, for example, is made from glass of type N-BK7 with a thickness of three (3) mm for example.

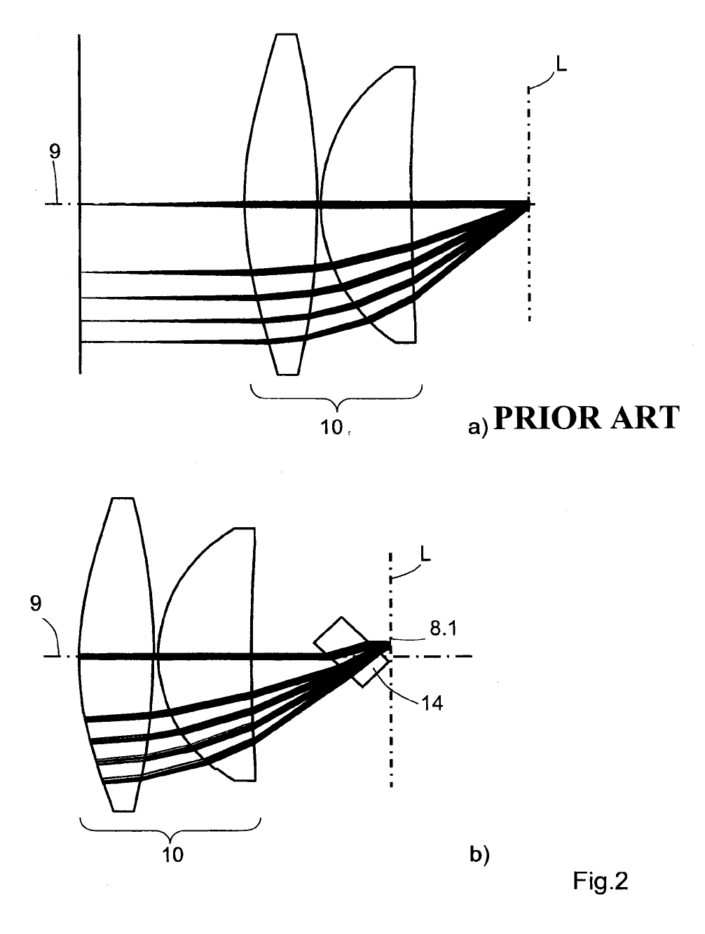

When this arrangement is operated, the glass plate 14 is made to rotate, so that due to its tilt relative to the optical axis 9 and depending on the current angle of rotation reached during the rotation, the light of the four light-radiating surfaces 8.1, 8.2, 8.3, 8.4 is deflected in succession to the position of a light source centered at the optical axis 9 as illustrated in FIG. 2b.

As shown in FIG. 1a with the light-radiating surface 8.1 as an example, the object 7 is also illuminated with light of the other light-radiating surfaces 8.2, 8.3, 8.4 in succession, whereas each time the others do not take part in illuminating the object 7.

To ensure, in addition, that object 7 is illuminated exclusively with light of one of the light-radiating surfaces 8.1, 8.2, 8.3, 8.4 at a time, optionally a switching array or componentry provides for the respective LED 12.1, 12.2, 12.3 or 12.4 to be switched on for a time in tune with the angle of rotation, whereas the other three LEDs remain switched off For this purpose, a control circuitry 15 is provided, which is connected, via signal paths, with the individual LEDs 12.1, 12.2, 12.3, 12.4, an electromechanical drive unit 16 couples the glass plate 14 and with the camera 5 which effects the switching on of the LEDs 12.1, 12.2, 12.3, 12.4 and of the camera 5 depending on the currently reached angle of rotation of the glass plate 14.

In this way, an image of the object 7 is obtained with the object 7 illuminated independently with light of each one of the light-radiating surfaces 8.1, 8.2, 8.3, 8.4. The foregoing arrangement can be used, for example: in classical light microscopy, where the spectral ranges of the individual light-radiating surfaces 8.1, 8.2, 8.3, 8.4 can be selected so that a white-light spectrum is covered in the best possible extent, for obtaining single specific color micrographs with the object being illuminated with light of a particular spectral range, and also in fluorescence microscopy, in which case each of the light-radiating surfaces 8.1, 8.2, 8.3, 8.4 radiates an excitation spectrum of a particular fluorescent dye contained in the object.

FIG. 2a illustrates, as an example, the position denoted by a dashed line “L” of a light source in relation to a specifically arranged collector 10 as is common in the prior art. Here, the light source is arranged at the center of the optical axis 9 of the collector 10, and the light coming from the light source is irradiated into the condenser 11 (not depicted in FIGS. 2a) in the direction of the optical axis 9.

The arrangement according to one embodiment of the invention differs from the prior art as follows. As shown exemplarily in FIG. 2b with the light-radiating surface 8.1, this is arranged at a lateral offset from the optical axis 9 of the condenser 10. For the sake of clarity, the other three light-radiating surfaces 8.2, 8.3, 8.4 are not shown; rather, they are arranged together with the light-radiating surface 8.1 in a plane whose normal is parallel with the optical axis 9. The light-radiating surfaces 8.1, 8.2, 8.3, 8.4, equally spaced on a circumscribed circle, concentrically surround the optical axis 9. Furthermore, FIG. 2b shows the tilt of the glass plate 14. Because of this tilt, the light radiated from the light exiting surface 8.1 is deflected such as if the light source were on the optical axis. In this position, a virtual light source is thus created, which corresponds to the light-radiating surface 8.1.

When the invented arrangement is operated, with every quarter-turn of the glass plate 14 about the optical axis 9, the light of a different light-radiating surface 8.1, 8.2, 8.3 or 8.4, respectively, is deflected to the position mentioned before, and used for illuminating the object.

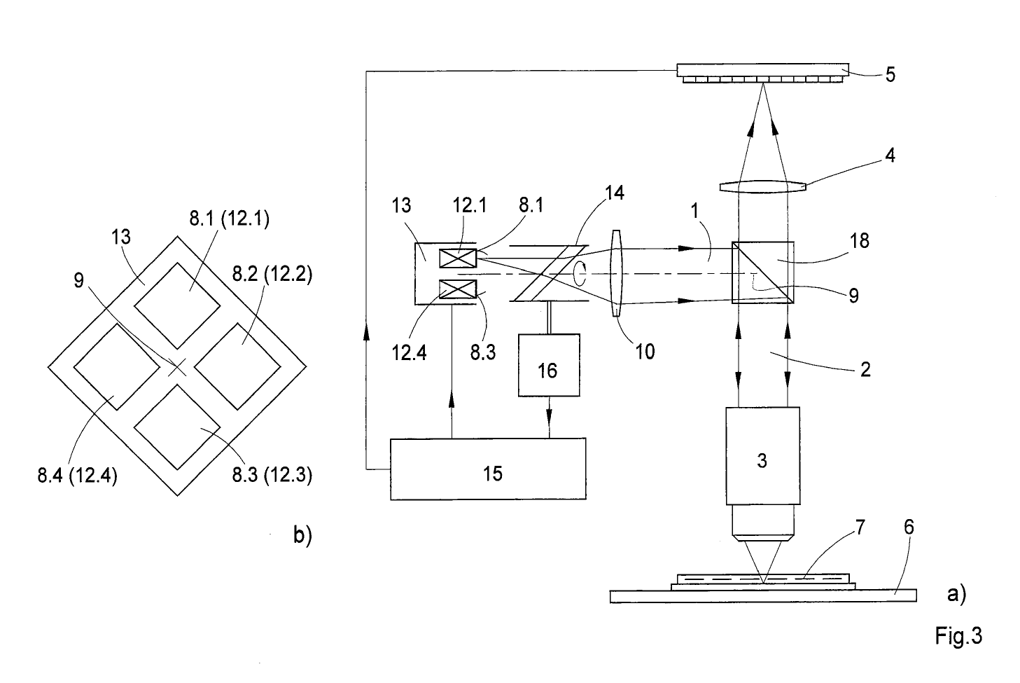

FIG. 3 illustrates an exemplary embodiment of another member of the family of microscope arrangements for imaging an object by reflected light. For the sake of clarity, components whose functions have been explained already with regard to FIG. 1 bear the same reference numbers as there, so that the illustration in FIG. 3 is, for the most part, self- explanatory.

Unlike the embodiment example shown in FIG. 1, the optical illuminating system of the version according to FIG. 3 comprises the collector 10 and the objective 3. Here, the light coming from the light-radiating surfaces 8.1, 8.2, 8.3, 8.4, which here again is generated by high-power LEDs 12.1, 12.2, 12.3, 12.4, coupled into the imaging ray path 2.

To accomplish said coupling, a beamsplitter 18 is arranged in the imaging ray path 2 between the tube lens 4 and the objective 3. This beamsplitter 18 has a beam-splitting coating that deflects the coupled-in illuminating light towards the objective 3, whereby the currently active light-radiating surface 8.1, 8.2, 8.3 or 8.4 is imaged in the exit pupil (not shown in the drawing) of the objective 3 so that the object 7 is illuminated with light having the desired spectrum.

The light reflected or scattered by the object 7 then passes the objective 3 again, forming the imaging ray path 2, passes the beam-splitting coating of the beamsplitter 18 and the tube lens 4, and is imaged onto the image sensor of the camera 5.

In this embodiment again, the invented microscope arrangement can be used not only in classical light microscopy as just described, but also in fluorescence microscopy, where each of the light-radiating surfaces 8.1, 8.2, 8.3, 8.4 radiates the excitation spectrum of a particular fluorescent dye. In this case, the beamsplitter 18 is configured as a multiband beamsplitter.

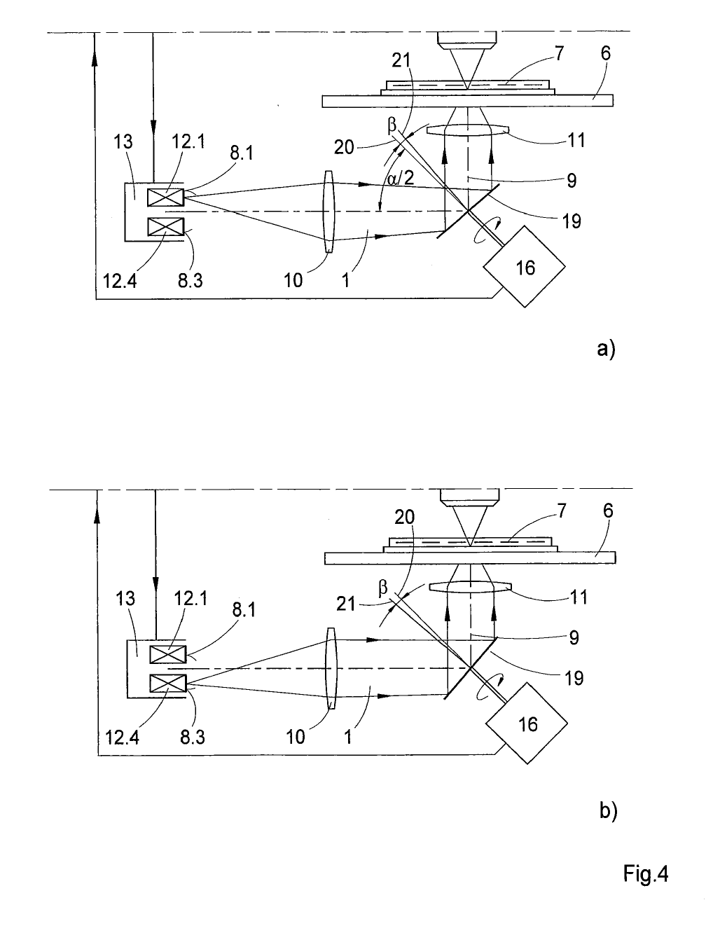

Similar to FIG. 1 and FIGS. 4a and 4b show a version of other members of the family of invented microscope arrangements, designed for imaging the object with transmitted-light illumination; here, however, the deflecting means provided is a rotatable mirror 19. FIG. 4a again uses like reference numbers for components like those in FIG. 1.

The mirror 19 should be positioned at or at least near the collector's focal point that is facing away from the light-radiating surfaces 8.1, 8.2, 8.3, 8.4. The mirror 19 deflects the illuminating ray path. The rotation axis 20 of the mirror 19 coincides with the bisector of the angle a by which the optical axis 9 of the optical illuminating system is bent due to the said deflection, whereas the normal 21 to the mirror surface is tilted by an angle β relative to the rotation axis 20, so that, during the rotation of the mirror 19, the tilt of the mirror surface relative to the incident illuminating ray path changes. Upon every quarter-turn, the lateral offset between the optical axis 9 and the light-radiating surfaces 8.1, 8.2, 8.3, 8.4 in succession is compensated. Because of the rotation of the mirror 19, the light of the light-radiating surfaces 8.1, 8.2, 8.3, 8.4 is sequentially or temporally directed to the object.

This is shown by FIG. 4a with the light-radiating surface 8.1, and by FIG. 4b with the light-radiating surface 8.3 as an example. The light-radiating surfaces 8.1, 8.3 lie in the plane of the drawing, whereas the light-radiating surface 8.2 lies behind, and the light-radiating surface 8.4 in front of, the plane of the drawing. For these light-radiating surfaces 8.2, 8.4 not visible in FIG. 4, the principle of deflection is, analogously, the same as for the light-radiating surfaces 8.1, 8.3.

### EXAMPLES

The following numbered Examples are intended to illustrate and not in any way limit the scope, breadth, or reach of the instant disclosure but should help inform those of skill in the art as to several perhaps subtle variations and aspects of the embodiments of the foregoing description and drawings.

1. A microscope with a device for illuminating an object (7) with light of various spectral ranges, comprising:

several light-radiating surfaces (8.1, 8.2, 8.3, 8.4) detached from each other, an optical illuminating system consisting of optical components, through which an illuminating ray path (1) is directed at the object (7), with the light-radiating surfaces (8.1, 8.2, 8.3, 8.4) radiating different spectral ranges, being arranged in a plane normal to the optical axis (9) of the optical illuminating system, and being, in this plane, laterally offset from the optical axis (9) of the optical illuminating system; and

a deflecting means, configured for the sequential change of direction of the light coming from the light-radiating surfaces (8.1, 8.2, 8.3, 8.4), so that as the direction changes, the light is deflected into the optical illuminating system and the lateral offset of the light-radiating surfaces (8.1, 8.2, 8.3, 8.4) is compensated.

2. A microscope according to Example 1, characterized in that: four light-radiating surfaces (8.1, 8.2, 8.3, 8.4) are provided, which concentrically surround the optical axis (9), wherein each light-radiating surface (8.1, 8.2, 8.3, 8.4) is assigned to one quadrant of the overall light-radiating surface, and wherein each light-radiating surface (8.1, 8.2, 8.3, 8.4) is optically coupled with at least one light source, preferably an LED (12.1, 12.2, 12.3, 12.4).

3. A microscope according to Example 2, configured for four-channel fluorescence microscopy, wherein each of the light-radiating surfaces (8.1, 8.2, 8.3, 8.4) radiates the excitation spectrum of a particular fluorescent dye.

4. A microscope according to any of the preceding Examples, configured for observation of the object (7) with transmitted-light illumination or for observation of the object (7) with reflected-light illumination.

5. A microscope according to any of the preceding Examples, wherein the deflecting means is configured as a rotatably supported transparent glass plate (14) or a rotatably supported mirror (19).

6. A microscope according to Example 5, equipped with a control circuitry (15) that is designed to effect at least one of to:

set a rotary speed for the glass plate (14) or the mirror (19),

one of switch the light sources or selectively block the light sources in synchronism with the angle of rotation of the glass plate (14) or of the mirror (19), and

control a camera (5) in synchronism with the rotary speed, so that the control circuitry (15) effects sequential switching on and off of the various light sources, in synchronism therewith, effect illumination of the object (7) with the light of a discrete one of the light- radiating surfaces (8.1, 8.2, 8.3, 8.4) at a time, and in synchronism therewith effect micrography of the object by means of the camera (5).

7. A microscope according to Example 5 or Example 6, wherein a glass plate (14) is provided that is made of type N-BK7 glass, is three (3) mm thick and is tilted by about between 45 degrees and about 90 degrees relative to an optical axis.

Thus select members of the family of inventive compact microscopes having multispectral object illumination have been described and depicted and the examples given of such microscopes should not be viewed as limiting as to the breadth and scope of the foregoing disclosure or of the specific examples given, but rather shall be governed only by broadest reasonable construction of the following claims, as understood and interpreted by those of skill in the art to which they are directed.

We claim:

1. A microscope with a device for illuminating an object with light of various spectral ranges, comprising:
several light-radiating surfaces detached from each other, an optical illuminating system consisting of optical components, through which an illuminating ray path is directed at the object, with the light-radiating surfaces radiating different spectral ranges, being arranged in a plane normal to the optical axis of the optical illuminating system, and being, in this plane, laterally offset from the optical axis of the optical illuminating system, and
a deflecting means, configured for the sequential change of direction of the light coming from the light-radiating surfaces, so that as the direction changes, the light is deflected into the optical illuminating system and the lateral offset of the light-radiating surfaces is compensated.

2. A microscope according to claim 1, wherein:
four light-radiating surfaces are provided, which concentrically surround the optical axis, wherein
each light-radiating surface is assigned to one quadrant of the overall light-radiating surface, and
each light-radiating surface is optically coupled with at least one light source, selected from a group consisting of: a light-emitting diode (LED), a high power LED, and a laser.

3. A microscope according to claim 2, configured for four-channel fluorescence microscopy, wherein each of the light-radiating surfaces radiates the excitation spectrum of a particular fluorescent dye.

4. A microscope according to claim 1, configured for observation of the object with transmitted-light illumination or for observation of the object with reflected-light illumination.

5. A microscope according to claim 1, wherein the deflecting means is configured as one of:
a rotatably supported transparent glass plate,
a rotatably supported mirror, or
a rotatably supported half-silvered mirror.

6. A microscope according to claim 5, equipped with a control circuitry that is designed to set a rotary speed for the glass plate or one of the mirrors, to switch the light sources in synchronism with the angle of rotation of the glass plate or of one of the mirrors, and to control a camera in synchronism with the rotary speed, so that the control circuitry (15) effects sequential switching on and off of the various light sources, in synchronism therewith, illumination of the object with the light of one of the light-radiating surfaces at a time, and in synchronism therewith, micrography of the object occurs via the camera.

7. A microscope according to claim 6, wherein a glass plate is provided that is made of type N-BK7 glass, is 3 mm thick and is tilted by about 45 degrees relative to an central optical axis of light impinging thereon.

8. A microscope, comprising:
a plurality of light-radiating surfaces sharing a common supporting structure and spaced apart from adjacent light-radiating surfaces;
an optical illuminating system consisting of optical components, through which an illuminating ray path is directed at an object to be imaged, wherein each of the light-radiating surfaces a) radiate at a distinct spectral range, b) are arranged in a plane normal to the optical axis of the optical illuminating system, and c) are laterally offset in the plane from the optical axis of the optical illuminating system; and
a deflecting assembly, configured to effect sequential change of direction of the light coming from the light-radiating surfaces so that as the direction changes the light is deflected into the optical illuminating system and the lateral offset of the light-radiating surfaces is substantially compensated.

9. A microscope according to claim 8, wherein the light-radiating surfaces each further comprise one of a light emitting diode (LED), a high energy LED, and a laser.

10. A microscope according to claim 8, wherein the deflecting assembly comprises one of: a rotating partially reflecting or half-silvered mirror and a transparent plate of glass and wherein said mirror or said glass, respectively, is disposed at approximately 45 degrees from a light path defined therethrough.

11. A microscope according to claim 9, wherein the LED comprises a 2×2 binning array arranged component disposed in a common plane upon the common supporting structure and wherein the structure is coupled to the deflecting assembly.

12. A microscope according to claim 8, wherein the deflecting assembly operates responsive to electronic control circuitry to at least one of:
set a rotary speed of rotation or to set dwell times for incremental, step-wise, rotation, and to switch the light radiating sources in synchronization with the angle of rotation of the light radiating sources relative to a light path, and to control a camera in synchronization with the rotary speed and the current angle of rotation of the light radiating sources.

13. A microscope according to claim 8, wherein the microscope is configured for multi- channel fluorescent imaging and the light-radiating surfaces emit energy designed to excite at least one fluorescent dye or a fluorescent stain adapted to be applied to the object to be imaged.

14. A microscope according to claim 8, wherein the deflecting assembly further comprises a temporally-activated blocking member that allows only a single spectrum of energy from the light-radiating surfaces to pass therethrough and impinge upon the object to be imaged.

15. A microscope according to claim 8, wherein the deflecting assembly further comprises a temporally-activated switching mechanism that allows only a single spectrum of energy from the light-radiating surfaces to be activated and pass therefrom at a given moment in time and impinge upon the object to be imaged.

16. A microscope according to claim 8, wherein the optical illuminating system comprises at least one segment of optical fiber.

17. A microscope, comprising:
at least four discrete radiation-emitting members coupled to one of: a dedicated discrete separate substrate for each of the members and a common substrate and wherein the members are spaced apart and wherein the radiation-emitting members each provide a unique spectral signature when activated;
at least one optical fiber coupled to each of the at least four radiation-emitting members at a first end; and
structure adapted to sequentially optically couple each of the optical fibers to an object of interest disposed on an imaging platform of a microscope.

18. A microscope according to claim 17, wherein the structure adapted to sequentially optically couple the optical fibers comprises an array of temporal switches that operate to cause impingement of the radiation from the radiation-emitting members upon the object of interest so that a composite spectral image including each of the unique spectral signatures is generated.

19. A microscope according to claim 17, wherein the structure adapted to sequentially optically couple further comprises a temporally-activated blocking member that allows only a single spectrum of energy from the radiation-emitting members to pass through the optical fibers and impinge upon the object of interest.

20. A microscope according to claim 17, wherein the structure adapted to sequentially optically couple further comprises a temporally-activated switching mechanism that allows only a single spectrum of energy from the radiation-emitting members to be activated and pass through the optical fibers at a given moment in time and subsequently impinge upon the object to be imaged.

21. A method of sequentially radiating diverse spectra radiation upon an object to be imaged, comprising:
energizing at least one of a plurality of adjacent light-radiating surfaces that are spaced apart from the other of the adjacent light-radiating surfaces to generate a discrete spectrum of radiant energy from the at least one of the plurality of adjacent light-radiating surfaces;
deflecting with a deflector unit the discrete spectrum of radiant energy into an optical illuminating system consisting of optical components, through which an illuminating ray path is defined, toward an object to be imaged, moving the deflector unit so that a discrete spectrum of radiant energy from another one of the plurality of adjacent light radiating surfaces is deflected into the optical illuminating system.

22. A method according to claim 21, wherein the deflector unit is moved in a rotational manner.

23. A method according to claim 21, wherein the light-radiating surfaces each further comprise one of a light emitting diode (LED), a high energy LED, and a laser.

24. A method according to claim 21, wherein the method is applied to effect multi-channel fluorescent imaging and the light-radiating surfaces emit energy designed to excite at least one fluorescent dye or a fluorescent stain adapted to be applied to the object to be imaged.
